(19) United States
(12) Patent Application Publication
(10) Pub. No.: US 2022/0123277 A1
(43) Pub. Date: Apr. 21, 2022

(54) MANUFACTURING METHOD OF CARBIDE

(71) Applicant: NATIONAL TSING HUA UNIVERSITY, Hsinchu (TW)

(72) Inventors: Yu-Lun CHUEH, Hsinchu City (TW); Shu-Chi WU, Tainan City (TW); Yi-Chung WANG, Hsinchu City (TW)

(21) Appl. No.: 17/211,851

(22) Filed: Mar. 25, 2021

(30) Foreign Application Priority Data
Oct. 16, 2020 (TW) 109135989

(51) Int. Cl. H01M 4/04; H01M 4/587; H01M 4/58

(52) U.S. Cl. CPC H01M 4/0471; H01M 4/581; H01M 4/587

(57) ABSTRACT

A manufacturing method of a carbide includes steps as follows. A carbon source is provided, a contacting step, a heating step and an electrochemical step are performed. The carbon source includes an amorphous carbon and a compound. The compound is a chalcogen compound, a pnictide compound, a halide, a hydroxide or a salt of a metal or a metalloid. In the contacting step, the carbon source is disposed in an alkaline earth metal halide to form a reactant. In the heating step, the reactant is heated to form a heated reactant. In the electrochemical step, a current is applied to the heated reactant, wherein the current passes through the carbon source, so as to make the alkaline earth metal halide, the amorphous carbon and the compound react with one another to form a carbide of the metal or the metalloid.

### RELATED APPLICATIONS

This application claims priority to Taiwan Application Serial Number 109135989, filed Oct. 16, 2020, which is herein incorporated by reference.

### BACKGROUND

### Technical Field

The present disclosure relates to a molten salt electrochemical method. More particularly, the present disclosure relates to a molten salt electrochemical method for manufacturing carbides.

### Description of Related Art

Amorphous carbon is a kind of carbon with relatively low crystallinity. Amorphous carbon includes lots of functional groups consisting of hydrogen, oxygen and nitrogen atoms, which forms the irregular crystalline structure of amorphous carbon. It is possible for the structure of amorphous carbon to regularly rearrange by applying high temperature to the amorphous carbon, and the amorphous carbon will turn into graphite with high crystallinity. The abovementioned process is called graphitization.

According to the structural difference, the amorphous carbon can be divided into soft carbon, which is easy to be graphitized, and hard carbon, which is difficult to be graphitized. The crystalline arrangement of soft carbon is more similar to graphite. Petroleum coke, coke and carbon fibers all belong to soft carbon. The crystalline arrangement of hard carbon is more chaotic than soft carbon, and the reactivity of hard carbon is lower than soft carbon. Carbonized polymers, charcoal, carbon black, carbohydrates and plant fibers are common hard carbon.

For example, for the graphitization of soft carbon or hard carbon, the soft carbon should be heated at a temperature over 2500° C. for 48-120 hours to form graphite, and the hard carbon is difficult to become graphite even in a high temperature environment over 2500° C. Thus, it could be understood that the reaction conditions of amorphous carbon are severe. It needs lots of energy and time to process the amorphous carbon, which not only increases the processing cost, but also consumes plenty of environmental resources.

In this regard, it is still an unsolved problem to graphitize or modify the amorphous carbon under simple reaction conditions.

### SUMMARY

According to an embodiment of the present disclosure, a manufacturing method of a carbide includes steps as follows. A carbon source is provided, a contacting step is performed, a heating step is performed and an electrochemical step is performed. The carbon source includes an amorphous carbon and a compound, and the compound is a chalcogen compound, a pnictide compound, a halide, a hydroxide or a salt of a metal, or a chalcogen compound, a pnictide compound, a halide, a hydroxide or a salt of a metalloid. The contacting step is performed by disposing the carbon source in an alkaline earth metal halide to form a reactant. The heating step is performed by heating the reactant in an inert atmosphere to make the alkaline earth metal halide of the reactant into a molten state, so as to form a heated reactant. The electrochemical step is performed by applying a current to the heated reactant, wherein the current passes through the carbon source, so as to make the alkaline earth metal halide, the amorphous carbon and the compound react with one another to form the carbide, and the carbide is a carbide of the metal or a carbide of the metalloid.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a manufacturing method of a carbide according to an embodiment of the present disclosure.

FIG. 2 is an X-ray diffraction pattern of the products of Example 1, Example 2, Comparison 1 and Comparison 2.

FIG. 3 is a Raman spectrum of the product of Example 3.

FIG. 4 is an X-ray diffraction pattern of the products of Example 4, Example 5, Comparison 3 and Comparison 4.

FIG. 5A is a scanning electron microscopic image of the product of Comparison 3.

FIG. 5B is a scanning electron microscopic image of the product of Example 5.

FIG. 5C is a scanning electron microscopic image of the product of Comparison 4.

FIG. 6A is a photo of a carbon material of the aforementioned manufacturing method being rice husk and a scanning electron microscopic image of the carbon material after preprocessing.

FIG. 6B is a photo and a scanning electron microscopic image of the product manufactured of the rice husk in FIG. 6A by the aforementioned manufacturing method.

FIG. 7 is a Raman spectrum of the products of Example 6 to Example 8 and Comparison 5.

FIG. 8A is a photo of the carbon material of the aforementioned manufacturing method being sugarcane and a scanning electron microscopic image of the carbon material after preprocessing.

FIG. 8B is a photo and a scanning electron microscopic image of the product manufactured of the sugarcane in FIG. 8A by the aforementioned manufacturing method.

FIG. 9 is a Raman spectrum of the products of Example 9, Example 10 and Comparison 6.

FIG. 10 is an X-ray diffraction pattern of the products of Example 10 and Comparison 6.

FIG. 11A is a photo of the carbon material of the aforementioned manufacturing method being coffee ground and a scanning electron microscopic image of the carbon material after preprocessing.

FIG. 11B is a photo and a scanning electron microscopic image of the product manufactured of the coffee ground in FIG. 11A by the aforementioned manufacturing method.

FIG. 12 is a Raman spectrum of the products of Example 11 and Comparison 7.

FIG. 13 is an X-ray diffraction pattern of the products of Example 11 and Comparison 7.

FIG. 14A is a scanning electron microscopic image of the inside of the product of Example 12.

FIG. 14B is a scanning electron microscopic image of the inside of the product of Example 13.

FIG. 15 is a Raman spectrum of the products of Example 12 and Example 13.

FIG. 16 is an X-ray diffraction pattern of the products of Example 12 and Example 13.

### DETAILED DESCRIPTION

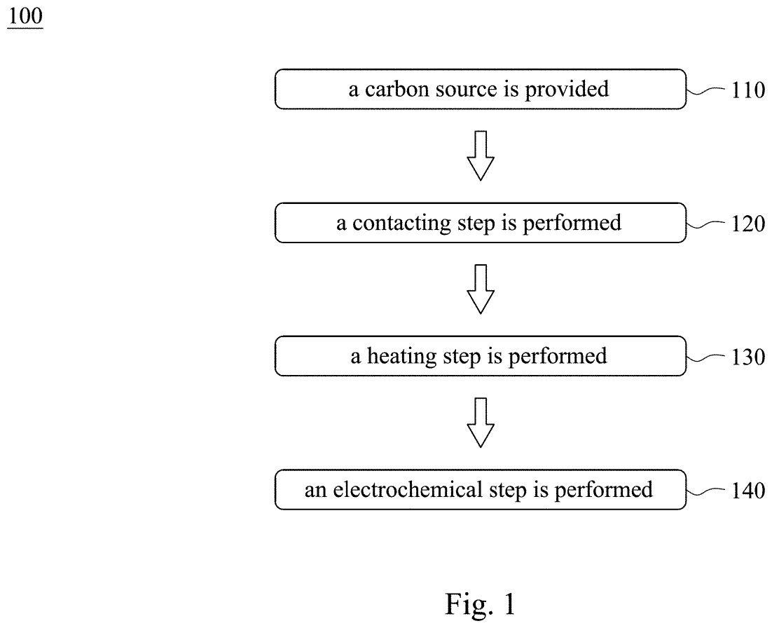

Please refer to FIG. 1. FIG. 1 is a flow chart of a manufacturing method of a carbide 100 according to an embodiment of the present disclosure. The manufacturing method of the carbide 100 includes Step 110, Step 120, Step 130 and Step 140.

In Step 110, a carbon source is provided. The carbon source includes an amorphous carbon and a compound.

The amorphous carbon can be obtained from a carbon material through preprocessing, and the carbon material can include a hydrocarbon or an organic polymer. In details, the carbon material can be a petroleum product, a plant waste, a resin, etc. According to the structural arrangement of the carbon material, the amorphous carbon made therefrom can be a hard carbon or a soft carbon. For example, if the carbon material has relatively chaotic 3D structure, such as alkanes or plants with cellulose or lignin, the amorphous carbon made therefrom is difficult to arrange into layer structure of graphite even through high-temperature treatment. Thus, this type of amorphous carbon belongs to the hard carbon. Conversely, if the carbon material has relatively regular structure, such as alkynes, the amorphous carbon made therefrom is easier to form graphite and belongs to the soft carbon. Both the hard carbon and the soft carbon can be made into the carbide by the present method, which means the manufacturing method of the carbide according to the present disclosure has a pretty wide range of applications.

The aforementioned preprocessing can be serial processes of acidic treating, washing, drying and dry-distilling. In the acidic treating, the carbon material is soaked in an acidic solution, so as to remove the possible metal impurities in the carbon material, such as sodium compounds, calcium compounds and potassium compounds which often exist in plants. The carbon material can be washed by deionized water and dried after the acidic treating. The carbon material can be dry-distilled after drying, so as to remove most of the non-carbon elements in the carbon material and form the amorphous carbon with high carbon content.

The compound is a chalcogen compound, a pnictide compound, a halide, a hydroxide or a salt of a metal, or a chalcogen compound, a pnictide compound, a halide, a hydroxide or a salt of a metalloid. The chalcogen compound can be an oxide, a sulfide, a selenide or a telluride. The pnictide compound can be a nitride or a phosphide. The halide can be a fluoride, a chloride, a bromide or an iodide. The salt can be a phosphinate, a borate, a perchlorate, a hypochlorite, an acetate, a phosphite, a sulfate, a sulfite, a carbonate, an oxalate or a phosphate. The metal can be Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, TI, Sn, Pb, Bi, Sc, Y, lanthanide or actinide. The metalloid can be B, Si, Ge, As or Sb.

The compound can be iron oxide (Fe₂O₃), a weight of iron oxide can be R₁ times as a weight of the amorphous carbon, and 0.11<R₁<10. The compound can be titanium oxide, a weight of titanium oxide is R₂ times as the weight of the amorphous carbon, and 0.11<R₂<10. The compound can be silicon oxide, a weight of silicon oxide is R₃ times as the weight of the amorphous carbon, and 0.43<R₃<9. By controlling the ratio between the compound and the amorphous carbon, the yield of the carbide can be increased. However, the type and ratio of the compound are not limitations to the present disclosure.

The carbon source can further include an additive. The additive can be an oxide or a halide of a transition metal, and the transition metal can be Cr, Mn, Fe, Co, Ni or Cu. It can facilitate the amorphous carbon breaking down into graphite microcrystal by adding the additive. The reactivity of the graphite microcrystal is better than the amorphous carbon, and the graphite microcrystal tends to react with the compound to form the carbide. Therefore, the yield of the carbide can be increased. Moreover, a weight percentage of the additive can be 0.1%-30% within the carbon source.

In Step 120, a contacting step is performed by disposing the carbon source in an alkaline earth metal halide to form a reactant. The alkaline earth metal halide can be selected from the group consisting of magnesium fluoride, calcium fluoride, strontium fluoride, barium fluoride, magnesium chloride, calcium chloride, strontium chloride, barium chloride, magnesium bromide, calcium bromide, strontium bromide, barium bromide, magnesium iodide, calcium iodide, strontium iodide and barium iodide. Compared to the conventional graphitization, which needs a reaction temperature up to 3000° C., the alkaline earth metal halide can turn into a molten state and react under a relatively low temperature. Thus, the consumption of energy and manufacturing costs are significantly saved.

Furthermore, the alkaline earth metal halide can be coordinated with an alkali metal halide, so as to effectively decrease the melting temperature of the molten salt through a eutectic reaction. For example, when the alkaline earth metal halide is magnesium chloride or calcium chloride, the reactant can further include sodium chloride, and a mole ratio between the alkaline earth metal halide and sodium chloride can be 6:4. Alternatively, the reactant can further include sodium chloride and potassium chloride, and a mole ratio between the alkaline earth metal halide, sodium chloride and potassium chloride can be 6:2:2.

In Step 130, a heating step is performed by heating the reactant in an inert atmosphere to make the alkaline earth metal halide of the reactant into the molten state, so as to form a heated reactant. The heating temperature in this step depends on the type and melting point of the alkaline earth metal halide. If the alkaline earth metal halide is the material listed above, the reactant can be heated to 500° C.-1500° C. to make the alkaline earth metal halide turn into the molten state, and then the following step can be performed.

In Step 140, an electrochemical step is performed by applying a current to the heated reactant. The current passes through the carbon source, so as to make the alkaline earth metal halide, the amorphous carbon and the compound in the heated reactant react with one another to form the carbide. The amorphous carbon includes lots of graphite microcrystals linked by functional groups containing oxygen, which forms the irregular 3D structure of the amorphous carbon. The molten alkaline earth metal halide can react with the amorphous carbon to remove the functional groups containing oxygen in the amorphous carbon. Thus, the graphite microcrystals are separated from the amorphous carbon. The graphite microcrystals can react with the compound of the carbon source to form the carbide with the current applied. The carbide formed is a carbide of the metal or a carbide of the metalloid according to the type of the compound, or the graphite microcrystals can be arranged to form a graphite.

In the electrochemical step, a voltage applied to the heated reactant can be −4 V to −0.1 V, so as to provide suitable voltage to form the carbide. The actual voltage can depend on the type, weight and ratio of the material. For example, if the weight of the carbon resource is 50 g-100 g, the current applied to the heated reactant can be 0.1 A-0.8 A.

Furthermore, the aforementioned manufacturing method of the carbide can be finished in 3-6 hours. The reaction time is significantly saved, and the energy and cost of the manufacturing process are also reduced.

In the following, the manufacturing method of the carbide according to the present disclosure is adopted with various types and ratio of the material and manufacturing conditions. X-ray diffraction analysis or Raman spectroscopic analysis of the manufactured products is performed, so as to determine the chemical compositions of the products.

1. Iron Oxide as Compound

In this experiment, iron oxide is chosen as the compound of the carbon source. The ratios between iron oxide and the amorphous carbon are shown in Table 1 below

TABLE 1
Ratios between Iron Oxide and Amorphous Carbon

| | Ratio of | Ratio | Weight Ratio |
|---|---|---|---|
| | Amorphous | of Iron | of Iron Oxide to |
| | Carbon | Oxide | Amorphous |
| | (wt. %) | (wt. %) | Carbon (Times) |
| Example 1 | 80 | 20 | 0.25 |
| Example 2 | 70 | 30 | 0.43 |
| Comparison 1 | 100 | 0 | 0 |
| Comparison 2 | 90 | 10 | 0.11 |

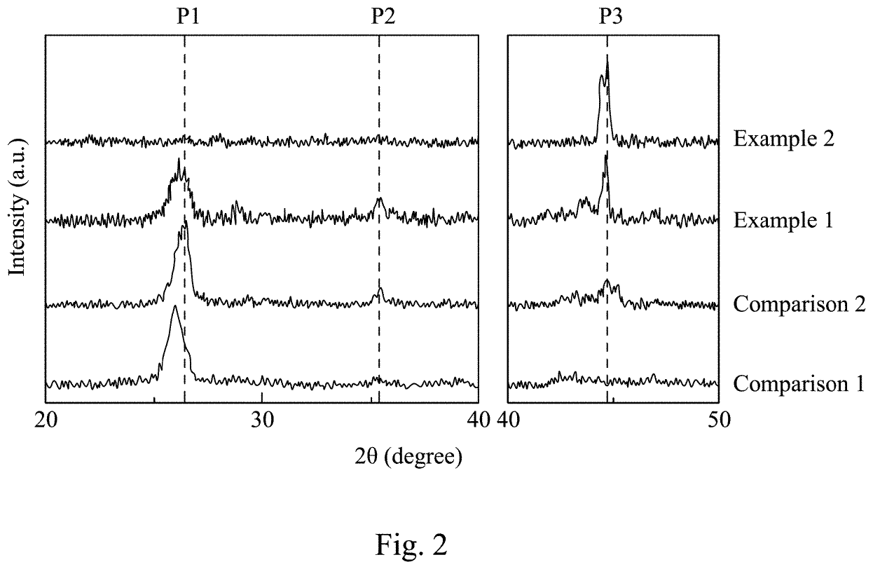

Please refer to FIG. 2. FIG. 2 is an X-ray diffraction pattern of the products of Example 1, Example 2, Comparison 1 and Comparison 2. In FIG. 2, the compositions of the products can be determined from characteristic peaks P1, P2, P3. The characteristic peak P1 corresponds to graphite, the characteristic peak P2 corresponds to iron oxide, and the characteristic peak P3 corresponds to iron carbide.

When the weight of iron oxide is 0 and 0.11 times as the weight of the amorphous carbon, there is no obvious characteristic peak P3 in the X-ray diffraction pattern of the products. When the weight of iron oxide is 0.25 and 0.43 times as the weight of the amorphous carbon, the intensity of the characteristic peak P3 in the X-ray diffraction pattern of the products is significantly enhanced. From the above results, it can be understood that iron carbide is difficult to be formed when iron oxide is insufficient.

Moreover, when the weight of iron oxide is 0.25 times as the weight of the amorphous carbon, it shows obvious characteristic peaks P1 and P3 in the X-ray diffraction pattern of the product, which means there are iron carbide and graphite in the product at the same time. However, when the weight of iron oxide is 0.43 times as the weight of the amorphous carbon, there are no characteristic peaks P1 and P2 in the X-ray diffraction pattern. The ratio between amorphous carbon and iron oxide is proper and tends to form iron carbide, and the yield of iron carbide can be increased by using this ratio.

2. Titanium Oxide as Compound

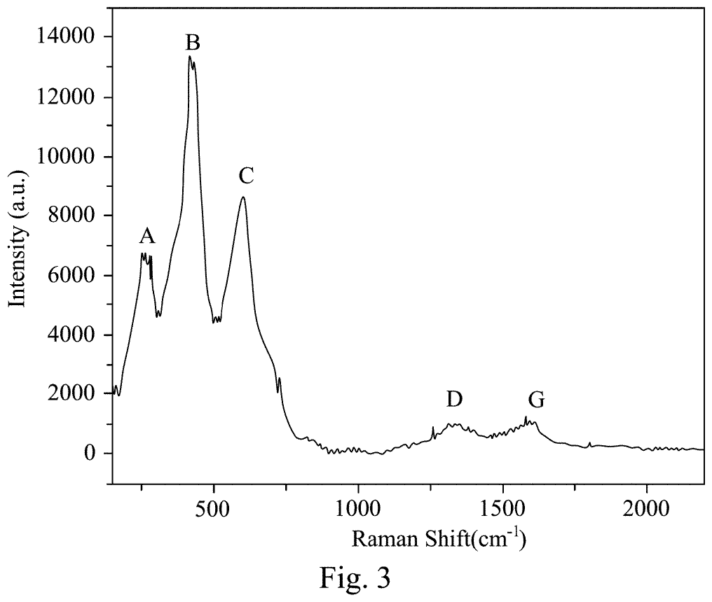

Please refer to FIG. 3. FIG. 3 is a Raman spectrum of the product of Example 3. In this experiment, titanium oxide is chosen as the compound of the carbon source of Experiment 3, and the weight of titanium oxide is 1 times as the weight of the amorphous carbon.

Peaks A, B, C, D and G can be read in FIG. 3. The peaks A, B and C correspond to titanium carbide, the peak D corresponds to the amorphous carbon, and the peak G corresponds to graphite. The peaks A, B and C have higher intensity than the peaks D and G, which means the titanium oxide can react with the amorphous carbon, and great amount of titanium carbide is formed by the manufacturing method of the present disclosure.

3. Silicon Oxide as Compound

In this experiment, silicon oxide is chosen as the compound of the carbon source. The ratios between silicon oxide and the amorphous carbon are shown in Table 2 below.

TABLE 2
Ratios between Silicon Oxide and Amorphous Carbon

| | Ratio of | Ratio of | Weight Ratio |
|---|---|---|---|
| | Amorphous | Silicon | of Silicon Oxide |
| | Carbon | Oxide | to Amorphous |
| | (wt. %) | (wt. %) | Carbon (Times) |
| Example 4 | 50 | 50 | 1 |
| Example 5 | 20 | 80 | 4 |
| Comparison 3 | 70 | 30 | 0.43 |
| Comparison 4 | 10 | 90 | 9 |

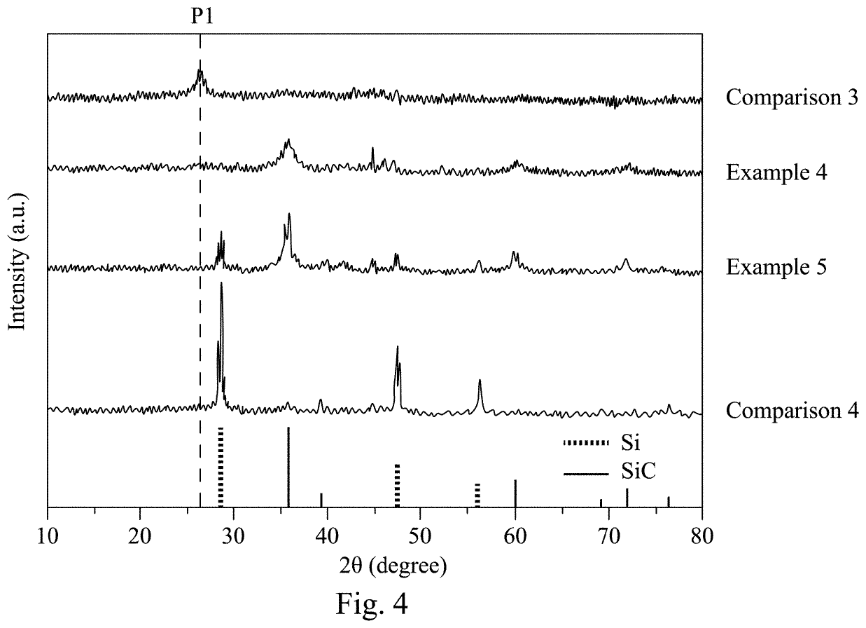

Please refer to FIG. 4. FIG. 4 is an X-ray diffraction pattern of the products of Example 4, Example 5, Comparison 3 and Comparison 4. In FIG. 4, the characteristic peak P1 corresponds to graphite, dotted lines below Example 4 correspond to characteristic peak values of silicon, and solid lines below Example 4 correspond to characteristic peak values of silicon carbide.

When the weight of silicon oxide is 1 and 4 times as the weight of the amorphous carbon, the X-ray diffraction pattern shows that the products mainly include silicon carbide. When the weight of silicon oxide is 0.43 times as the weight of the amorphous carbon, the characteristic peak P1 appears, which means graphite tends to be formed under this ratio. When the weight of silicon oxide is 9 times as the weight of the amorphous carbon, the characteristic peaks of silicon are pretty obvious, which means silicon tends to be formed under this ratio. According to the abovementioned experimental results, when the compound of the carbon source is silicon oxide, the weight of silicon oxide is preferably R₃ times as the weight of the amorphous carbon, and 0.43<R₃<9 to facilitate forming silicon carbide.

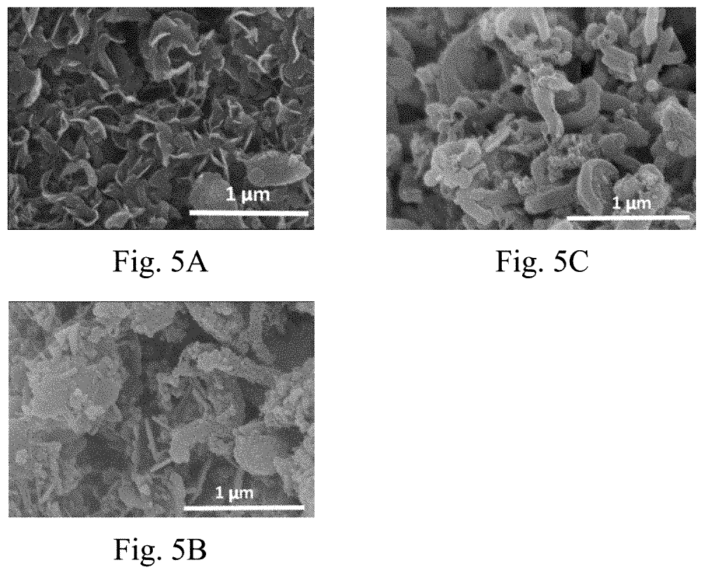

Please refer to FIG. 5A, FIG. 5B and FIG. 5C. FIG. 5A, FIG. 5B and FIG. 5C are scanning electron microscopic images of the products of Comparison 3, Example 5 and Comparison 4, respectively. The silicon carbide synthesized in this experiment has the structure of nanowire. Thus, in FIG. 5B, it can be observed that the product includes lots of linear needle-like structures which are crystals of silicon carbide. Conversely, there is no similar needle-like structure in FIG. 5A and FIG. 5C, and it can be determined that silicon carbide is relatively difficult to be synthesized in Comparison 3 and Comparison 4. Furthermore, graphite can be synthesized from the amorphous carbon in Comparison 3, so lots of flake crystals of graphite can be observed in FIG. 5A.

4. Different Types of Amorphous Carbon

In this series of experiments, rice husk, sugarcane and coffee ground are chosen as the carbon material, so as to obtain different types of amorphous carbon. It will be confirmed whether the manufacturing method of the carbide according to the present disclosure is applicable to every types of amorphous carbon or not.

4-1. Rice Husk as Carbon Material

Rice husk is chosen to manufacture the amorphous carbon in this experiment. The voltages in the electrochemical steps of different examples are respectively modified. The voltages applied in Example 6, Example 7 and Example 8 are −2.8 V, −2.6 V and −2.4 V, respectively.

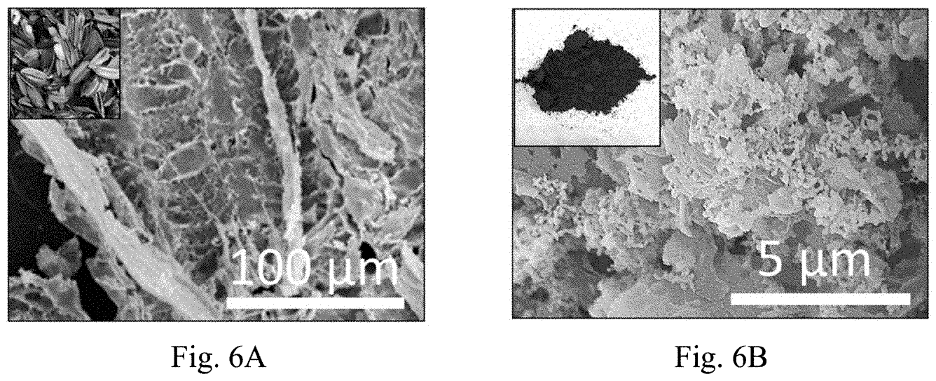

Please refer to FIG. 6A and FIG. 6B. FIG. 6A is a photo of the rice husk and a scanning electron microscopic image of the rice husk after preprocessing. FIG. 6B is a photo and a scanning electron microscopic image of the product manufactured of the rice husk in FIG. 6A by the aforementioned manufacturing method. By comparing the microscopic images of FIG. 6A and FIG. 6B, it can be observed that layer structure formed by graphite shows in FIG. 6B. Accordingly, it is understood that the rice husk can turn into graphite after being processed by the manufacturing method of the present disclosure.

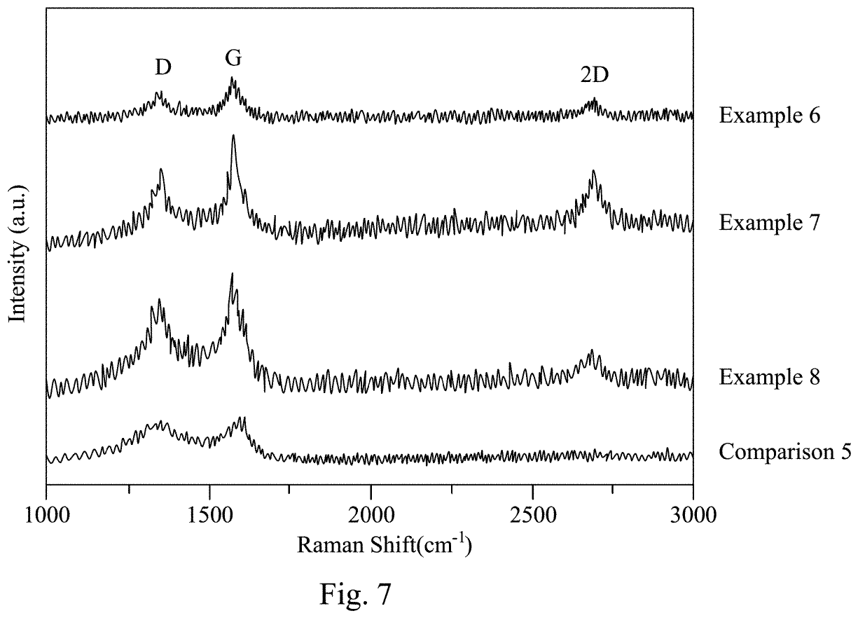

Please refer to FIG. 7. FIG. 7 is a Raman spectrum of the products of Example 6 to Example 8 and Comparison 5. Comparison 5 is the amorphous carbon made from the rice husk after preprocessing. Peaks D, G and 2D can be read in FIG. 7. The peak D corresponds to the amorphous carbon, and the peaks G and 2D correspond to graphite. Compared to Comparison 5, the differentiations between the peaks D and G of Example 6 to Example 8 are increased, and the peaks 2D appear in Example 6 to Example 8. It is further proved that the rice husk can successfully react to synthesize graphite by the manufacturing method of the present disclosure.

4-2. Sugarcane as Carbon Material

Sugarcane is chosen to manufacture the amorphous carbon in this experiment. The processing time of the electrochemical steps of different examples are respectively modified. The voltages applied in Example 9 and Example 10 are −2.8 V, and the electrochemical steps take 6 hours and 11 hours, respectively.

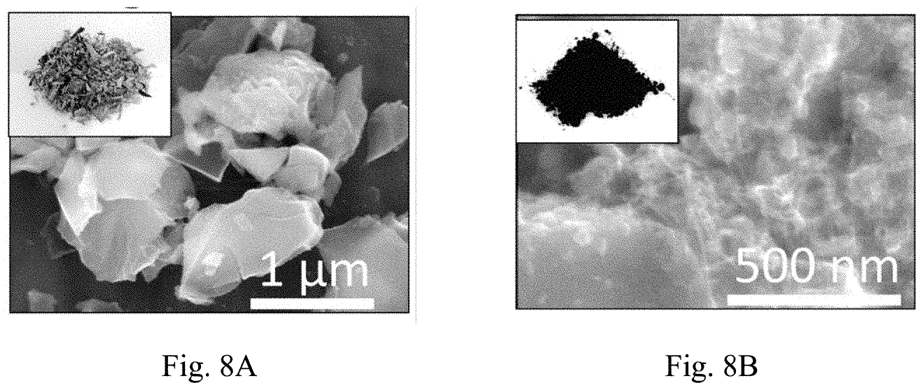

Please refer to FIG. 8A and FIG. 8B. FIG. 8A is a photo of the sugarcane and a scanning electron microscopic image of the sugarcane after preprocessing. FIG. 8B is a photo and a scanning electron microscopic image of the product manufactured of the sugarcane in FIG. 8A by the aforementioned manufacturing method. By comparing the microscopic images of FIG. 8A and FIG. 8B, it can be observed that layer structure formed by graphite shows in FIG. 8B. Accordingly, it is understood that the sugarcane can turn into graphite after being processed by the manufacturing method of the present disclosure.

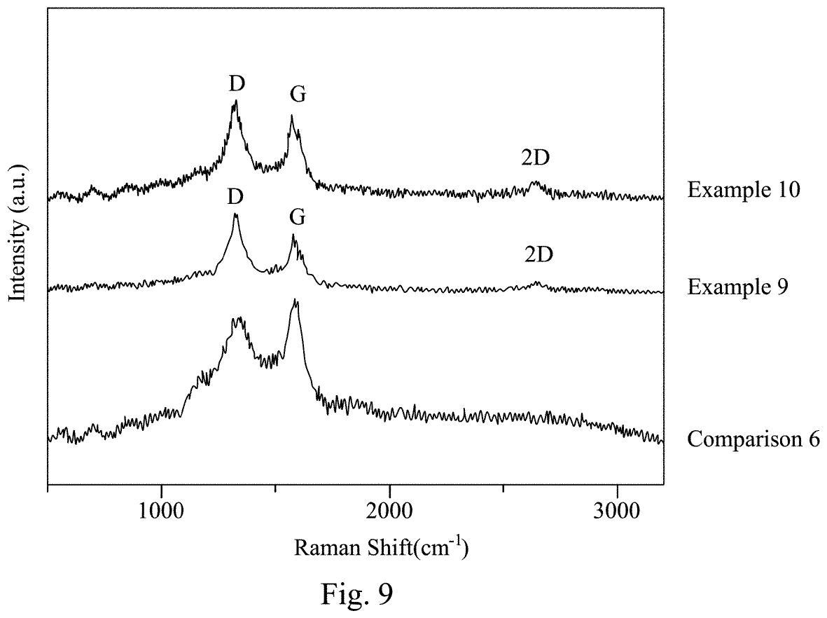

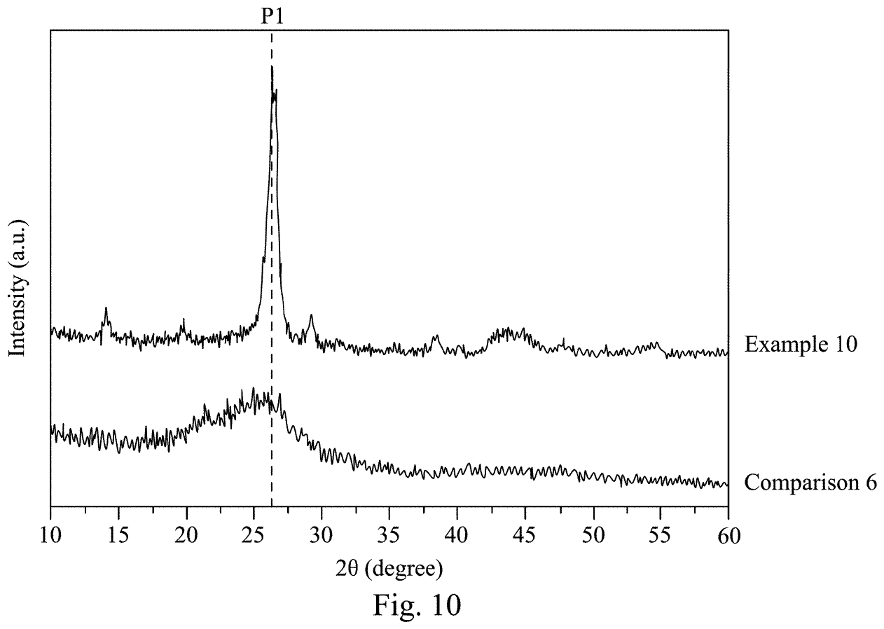

Please refer to FIG. 9 and FIG. 10. FIG. 9 is a Raman spectrum of the products of Example 9, Example 10 and Comparison 6. FIG. 10 is an X-ray diffraction pattern of the products of Example 10 and Comparison 6. Comparison 6 is the amorphous carbon made from the sugarcane after preprocessing. In FIG. 9, compared to Comparison 6, Example 9 and Example 10 have increased differentiations between the peaks D and G and both show the peaks 2D. In FIG. 10, the characteristic peak P1 which corresponds to graphite shows in Example 10. It is further proved that the sugarcane can successfully react to synthesize graphite by the manufacturing method of the present disclosure.

4-3. Coffee Ground as Carbon Material

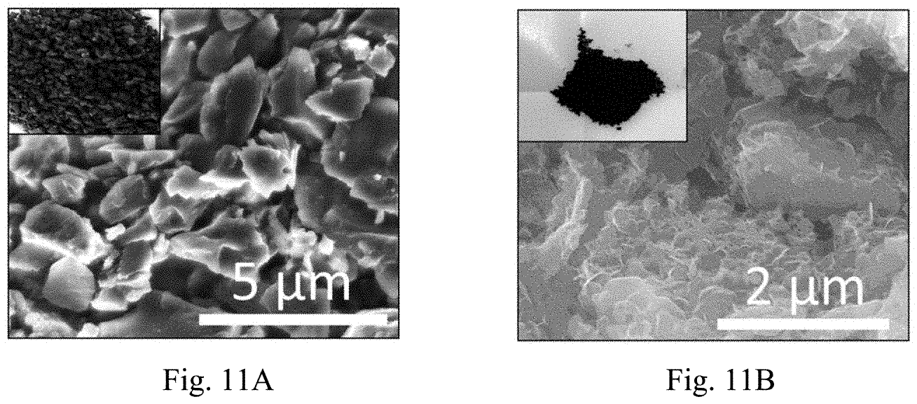

Coffee ground is chosen to manufacture the amorphous carbon in this experiment. Please refer to FIG. 11A and FIG. 11B. FIG. 11A is a photo of the coffee ground and a scanning electron microscopic image of the coffee ground after preprocessing. FIG. 11B is a photo and a scanning electron microscopic image of the product manufactured of the coffee ground in FIG. 11A by the aforementioned manufacturing method. By comparing the microscopic images of FIG. 11A and FIG. 11B, it can be observed that layer structure formed by graphite shows in FIG. 11B. Accordingly, it is understood that the coffee ground can turn into graphite after being processed by the manufacturing method of the present disclosure.

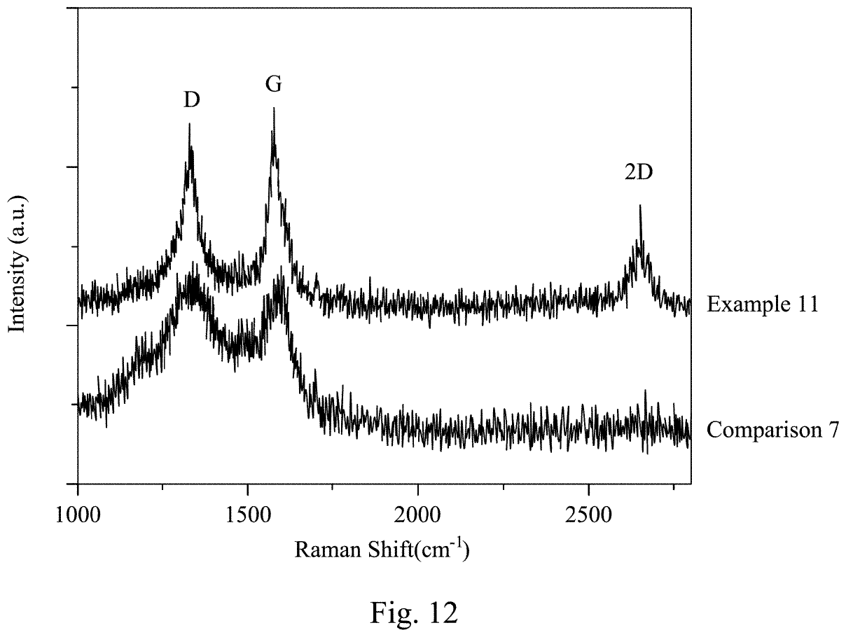

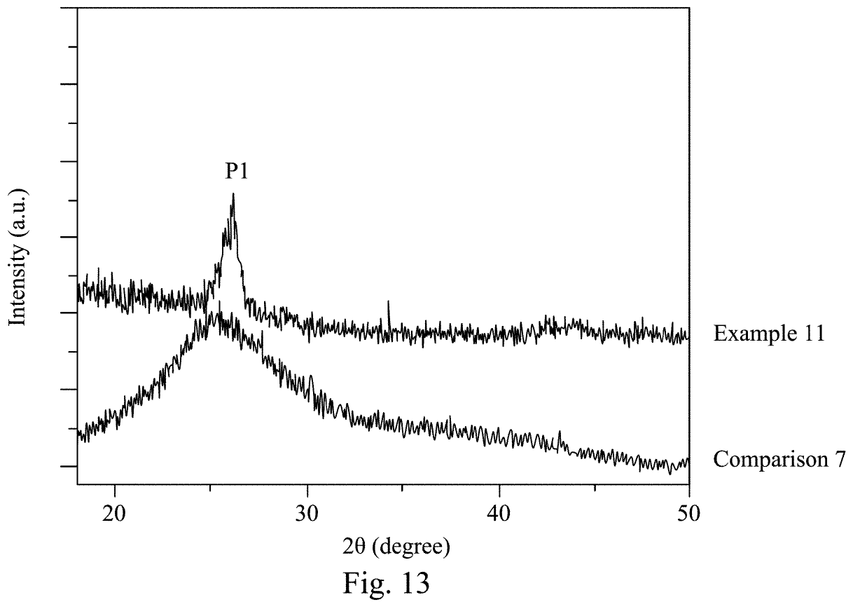

Please refer to FIG. 12 and FIG. 13. FIG. 12 is a Raman spectrum of the products of Example 11 and Comparison 7. FIG. 13 is an X-ray diffraction pattern of the products of Example 11 and Comparison 7. Comparison 7 is the amorphous carbon made from the coffee ground after preprocessing. In FIG. 12, compared to Comparison 7, Example 11 has increased differentiation between the peak D and G and shows the peak 2D. In FIG. 13, the characteristic peak P1 which corresponds to graphite shows in Example 11. It is further proved that the coffee ground can successfully react to synthesize graphite by the manufacturing method of the present disclosure.

5. Using Additive

In this experiment, the additive is added in the carbon source, and it is tested whether the additive helps the amorphous carbon break down into graphite microcrystal. The carbon source of this experiment is pressed into a shape of carbon tablet for reaction. The carbon tablet of Example 12 includes iron oxide as the additive. The carbon tablet of Example 13 is without the additive.

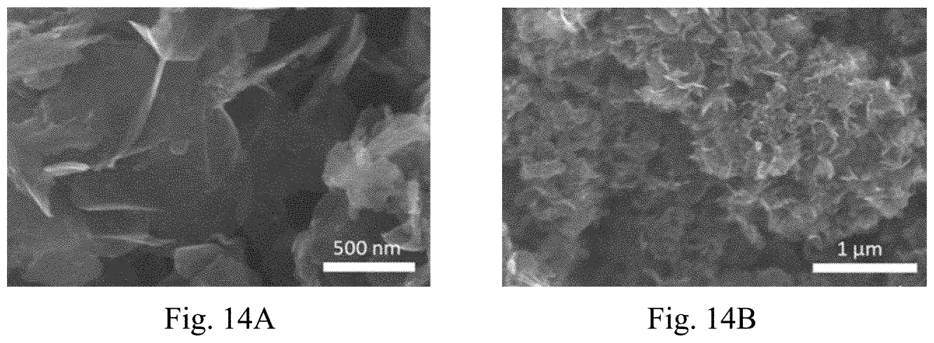

Please refer to FIG. 14A and FIG. 14B. FIG. 14A is a scanning electron microscopic image of the inside of the product of Example 12. FIG. 14B is a scanning electron microscopic image of the inside of the product of Example 13. It can be understood from FIG. 14A and FIG. 14B that, although layer structure of graphite appears inside of the carbon tablets of both Example 12 and Example 13, the layer structure of Example 12 is more orderly, which means that the graphitization degree of the carbon tablet of Example 12 is higher.

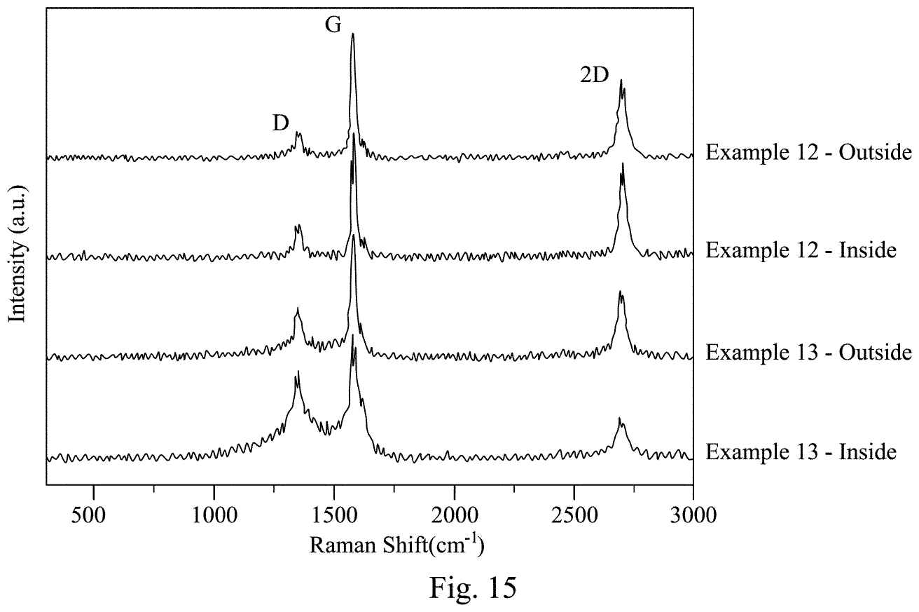

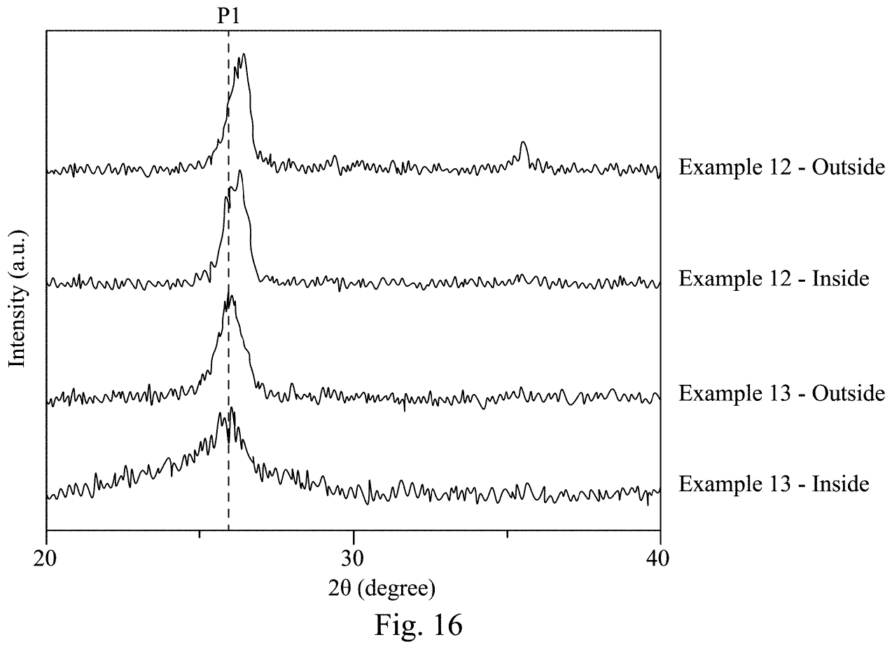

Please refer to FIG. 15 and FIG. 16. FIG. 15 is a Raman spectrum of the products of Example 12 and Example 13. FIG. 16 is an X-ray diffraction pattern of the products of Example 12 and Example 13. In FIG. 15, the differentiation between the peaks D and G and the intensity of the peak 2D detected from the inside of Example 12 are both higher than the inside of Example 13. In FIG. 16, the intensity of the characteristic peak P1 of the inside of Example 12 is significantly higher than the inside of Example 13. The aforementioned data shows that the overall graphitization degree of the carbon tablet of Example 12 is higher than Example 13. It means that the additive can help the amorphous carbon turn into graphite microcrystal. The graphite microcrystal can react with the compound to form the carbide, and the synthesizing efficiency of the carbide is indirectly enhanced.

In this regard, in the manufacturing method of the present disclosure, the molten alkaline earth metal halide first reacts with the amorphous carbon to remove the functional groups in the amorphous carbon. The amorphous carbon then turns into graphite microcrystal with regular crystal structure. The graphite microcrystal can react with the compound including the metal or the metalloid, so as to form the carbide. The reaction temperature and time and the complexity of manufacturing process can be reduced in this manufacturing method, which significantly saves the energy consumption and manufacturing cost.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A manufacturing method of a carbide, comprising:
providing a carbon source, which comprises an amorphous carbon and a compound;
performing a contacting step by disposing the carbon source in an alkaline earth metal halide to form a reactant;
performing a heating step by heating the reactant in an inert atmosphere to make the alkaline earth metal halide of the reactant into a molten state, so as to form a heated reactant; and
performing an electrochemical step by applying a current to the heated reactant, wherein the current passes through the carbon source, so as to make the alkaline earth metal halide, the amorphous carbon and the compound react with one another to form the carbide;
wherein the compound is a chalcogen compound, a pnictide compound, a halide, a hydroxide or a salt of a metal, or a chalcogen compound, a pnictide compound, a halide, a hydroxide or a salt of a metalloid, and the carbide is a carbide of the metal or a carbide of the metalloid.

2. The manufacturing method of the carbide of claim 1, wherein a graphite is further formed as performing the electrochemical step.

3. The manufacturing method of the carbide of claim 1, wherein the amorphous carbon is obtained from a carbon material through serial processes of acidic treating, washing, drying and dry-distilling.

4. The manufacturing method of the carbide of claim 3, wherein the carbon material comprises a hydrocarbon or an organic polymer.

5. The manufacturing method of the carbide of claim 1, wherein the chalcogen compound of the metal is a metal oxide, a metal sulfide, a metal selenide or a metal telluride, the pnictide compound of the metal is a metal nitride or a metal phosphide, the halide of the metal is a metal fluoride, a metal chloride, a metal bromide or a metal iodide, the salt of the metal is a metal phosphinate, a metal borate, a metal perchlorate, a metal hypochlorite, a metal acetate, a metal phosphite, a metal sulfate, a metal sulfite, a metal carbonate, a metal oxalate or a metal phosphate, and the metal is Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, TI, Sn, Pb, Bi, Sc, Y, lanthanide or actinide.

6. The manufacturing method of the carbide of claim 5, wherein the compound is iron oxide, a weight of iron oxide is R₁ times as a weight of the amorphous carbon, and 0.11<R₁<10.

7. The manufacturing method of the carbide of claim 5, wherein the compound is titanium oxide, a weight of titanium oxide is R₂ times as a weight of the amorphous carbon, and 0.11<R₂<10.

8. The manufacturing method of the carbide of claim 1, wherein the chalcogen compound of the metalloid is a metalloid oxide, a metalloid sulfide, a metalloid selenide or a metalloid telluride, the pnictide compound of the metalloid is a metalloid nitride or a metalloid phosphide, the halide of the metalloid is a metalloid fluoride, a metalloid chloride, a metalloid bromide or a metalloid iodide, the salt of the metalloid is a metalloid phosphinate, a metalloid borate, a metalloid perchlorate, a metalloid hypochlorite, a metalloid acetate, a metalloid phosphite, a metalloid sulfate, a metalloid sulfite, a metalloid carbonate, a metalloid oxalate or a metalloid phosphate, and the metalloid is B, Si, Ge, As or Sb.

9. The manufacturing method of the carbide of claim 8, wherein the compound is silicon oxide, a weight of silicon oxide is R₃ times as a weight of the amorphous carbon, and 0.43<R₃<9.

10. The manufacturing method of the carbide of claim 1, wherein the carbon source further comprises an additive.

11. The manufacturing method of the carbide of claim 10, wherein the additive is an oxide or a halide of a transition metal, and the transition metal is Cr, Mn, Fe, Co, Ni or Cu.

12. The manufacturing method of the carbide of claim 10, wherein a weight percentage of the additive is 0.1%-30% within the carbon source.

13. The manufacturing method of the carbide of claim 1, wherein the alkaline earth metal halide is selected from the group consisting of magnesium fluoride, calcium fluoride, strontium fluoride, barium fluoride, magnesium chloride, calcium chloride, strontium chloride, barium chloride, magnesium bromide, calcium bromide, strontium bromide, barium bromide, magnesium iodide, calcium iodide, strontium iodide and barium iodide.

14. The manufacturing method of the carbide of claim 13, wherein the alkaline earth metal halide is magnesium chloride or calcium chloride, the reactant further comprises sodium chloride, and a mole ratio between the alkaline earth metal halide and sodium chloride is 6:4.

15. The manufacturing method of the carbide of claim 13, wherein the alkaline earth metal halide is magnesium chloride or calcium chloride, the reactant further comprises sodium chloride and potassium chloride, and a mole ratio between the alkaline earth metal halide, sodium chloride and potassium chloride is 6:2:2.

16. The manufacturing method of the carbide of claim 13, wherein the reactant is heated to 500° C.-1500° C. as performing the heating step.

17. The manufacturing method of the carbide of claim 1, wherein a voltage applied to the heated reactant is −4 V to −0.1 V as performing the electrochemical step.
